(19) United States
(12) Patent Application Publication
(10) Pub. No.: US 2024/0196175 A1
(43) Pub. Date: Jun. 13, 2024

(54) METHOD FOR CONNECTING A WIRELESS SENSOR TO A GATEWAY AND ASSOCIATED NETWORK

(71) Applicant: Aktiebolaget SKF, Göteborg (SE)

(72) Inventors: Jens GRAF, Schweinfurt (DE); Clément POULAILLEAU, Amboise (FR); Simon HUBERT, Tours (FR)

(21) Appl. No.: 18/527,486

(22) Filed: Dec. 4, 2023

(30) Foreign Application Priority Data
Dec. 12, 2022 (DE) 102022213422.2

(51) Int. Cl. H04W 4/38; H04W 28/02; H04W 88/16

(52) U.S. Cl. CPC H04W 4/38; H04W 28/0231; H04W 88/16

(57) ABSTRACT

A network (1) including at least one wireless sensor (2, 3) having emitting means (8) for emitting a first signal (S11, S12), a plurality of gateways (4, 5, 6), and a network supervisor (7). The network supervisor (7) includes determining means (13) for determining for each gateway (4, 5, 6) a signal reception quality score (I111, I112, I113, I121, I122, I123) of the first signal (S11, S12) to quantify the quality of the reception of the first signal by the said gateway. The network supervisor (7) includes choosing means (14) for choosing a selected gateway (5, 6) from the plurality of gateways (4, 5, 6), the selected gateway having the highest signal reception quality score (I112, I123).

### CROSS-REFERENCE TO RELATED APPLICATION

This application claims priority to German Application No. 102022213422.2, filed Dec. 12, 2022, the entirety of which is hereby incorporated by reference.

### FIELD

The present invention is directed to a network comprising wireless sensors and gateways.

More particularly, the invention deals with connecting a wireless sensor to one gateway of the plurality of gateways.

### BACKGROUND

Generally, a network comprises wireless sensors communicating wirelessly with gateways to transmit measurements.

Generally, each wireless sensor is paired with a network comprising gateways. Each wireless sensor transmits the measurements to a gateway.

However, when an obstacle is localized between the wireless sensor and the gateway, the quality of the signal received by the gateway from the sensor may be deteriorate so that some frames of the signal are not received by the gateway.

In such a case, the gateway asks the wireless sensor to reemit the lost frames of the signal.

The reemission of the frames by the sensor consumes power.

As the wireless sensor is generally supplied by a battery to facilitate the implementation of the wireless sensor, the duration of the battery is reduced.

### SUMMARY

Consequently, the present invention intends to enhance the quality of the signal transmission between the wireless sensor and a gateway to reduce the energy consumption of the sensor.

According to an aspect a method for connecting at least one wireless sensor to a first gateway of a plurality of gateways is proposed.

The method comprises: an emission of a first signal by the sensor for each gateway, a determination of a signal reception quality score of the first signal to quantify the quality of the reception of the first signal by the said gateway, a choice of a selected gateway from the plurality of gateways, the selected gateway having the highest signal reception quality score.

The pairing of the sensor with the gateway having the highest signal reception quality score permits to optimize the quality of the transmission of measurements to avoid that the sensor has to emit at least two times same measurements to reduce the power consumption of the sensor.

Preferably, the sensor is in a sleep mode, the method comprises: a first start of the sensor before emitting the first signal comprising a non-connectable frame, a first switch of the sensor in the sleep mode after sending the first signal, a second start of the sensor after when a first predetermined duration has elapsed, the selected gateway being chosen, an emission of a second signal by the sensor, the second signal comprising a connectable frame, the second signal being processed by the selected gateway to establish a communication between the sensor and the selected gateway, an emission of a third signal by the sensor, the third signal comprising data extracted from measurements taken by the said sensor, the third signal being processed by the selected gateway, and a second switch of the sensor is the sleep mode after sending the third signal.

Advantageously, the steps are repeated after a predetermined duration.

According to another aspect, a network is proposed.

The network comprises: at least one wireless sensor comprising emitting means configured to emit a first signal comprising a non-connectable frame, a plurality of gateways, and a network supervisor, the network supervisor comprising: determining means configured to determine for each gateway a signal reception quality score of the first signal to quantify the quality of the reception of the first signal by the said gateway, and choosing means configured to choose a selected gateway from the plurality of gateways, the selected gateway having the highest signal reception quality score.

Preferably, the wireless sensor comprises a battery.

Advantageously, the wireless sensor further comprises control means configured to: start the sensor before emitting the first signal and when a first predetermined duration has elapsed representative, the network supervisor has chosen the selected gateway, and switch the sensor in a sleep mode after sending the first signal and after sending a third signal, the emitting means being further configured to: emit a second signal comprising a connectable frame to establish a communication between the sensor and the selected gateway, and emit the third signal comprising data extracted from measurements taken by the said sensor.

Preferably, the network supervisor comprises extraction means configured to reconstitute the measurements from the third signal.

Advantageously, the control means are further configured to start the sensor before emitting the first signal each time a predetermined duration has elapsed since the switch of the sensor in a sleep mode after emitting the third signal.

Preferably, the wireless sensor comprises measuring means configured to measure a temperature and/or an acceleration.

### BRIEF DESCRIPTION OF THE DRAWINGS

Other advantages and features of the invention will appear on examination of the detailed description of embodiments, in no way restrictive, and the appended drawings in which:

FIG. 1 illustrates schematically a network according to the invention; and

FIGS. 2-5 illustrate schematically a method for connecting a wireless sensor to a gateway according to the invention.

### DETAILED DESCRIPTION

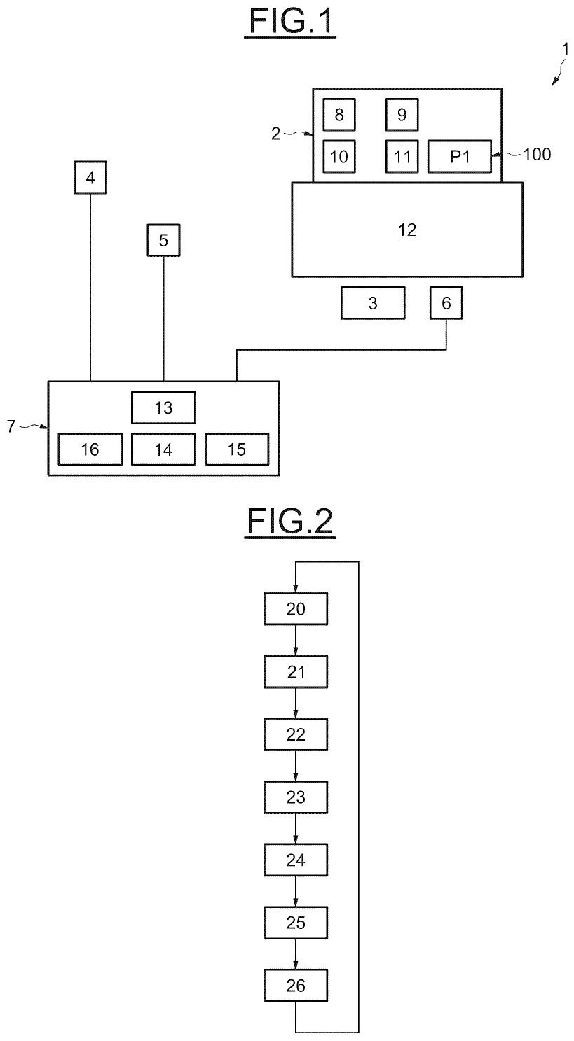

Reference is made to FIG. 1 which represents a network 1 comprising two wireless sensors 2, 3, three gateways 4, 5, 6 and a network supervisor 7 connected to the gateways 4, 5, 6.

In variant, the network 1 comprises more or less than two sensors and more or less than three gateways, the network 1 comprising at least one wireless sensor and two gateways.

As the two wireless sensors 2, 3 have the same architecture, only a first sensor 2 is detailed.

The first sensor 2 comprises emitting means 8 communicating wirelessly with the gateways 4, 5, 6, control means 9, and measuring means 10.

The first sensor 2 further comprises storing means 100 storing connection parameters P1.

The first sensor 2 further comprises a battery 11 supplying the emitting means 8, the control means 9, the measuring means 10.

The control means 9 comprise for example a processing unit implementing the emitting means 8, the measuring means 10, and the storing means 100.

The measurement means 10 comprise for example a measurement interface measuring the temperature outside the first sensor 2 and/or measuring the acceleration of a machine 12 on which the first sensor 2 is fixed.

The command means 10 comprise for example a processing unit implementing the communication means 9.

The network supervisor 7 comprises determining means 13, choosing means 14, and extraction means 15.

The network supervisor 7 further comprises a processing unit 16 implementing the determining means 13, the choosing means 14, and the extraction means 15.

The sensors 2, 3 and the gateways 4, 5, 6 communicate wirelessly, for example using a Bluetooth protocol.

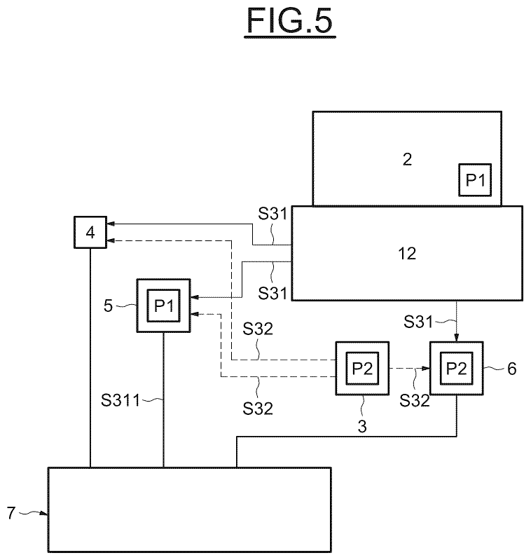

FIGS. 2, 3, 4, 5 illustrate an example of a method for connecting the sensors 2, 3 to the gateways 4, 5, 6.

During a step 20 (FIG. 2), the control means 9 of each sensor 2, 3 start the said sensor 2, 3 so that each sensor switches in an active mode, the measuring means 10 and the emitting means 8 being supplied by the battery.

In the active mode, the measuring means 10 are able to take measurements and the control means 9 are able to condition the measurements and the emitting means 8 are able to emit and receive signals.

In the sleep mode, the measuring means 10 and the emitting means 8 are not supplied by the battery.

During a step 21, the emitting means 8 of each sensor 2, 3 emit a first signal S11, S12.

The first signal S11, S12 comprises non-connectable frames.

After the emission of the first signal S11, S12, the control means 9 of each sensor 2, 3 switch the said sensor 2, 3 in the sleep mode.

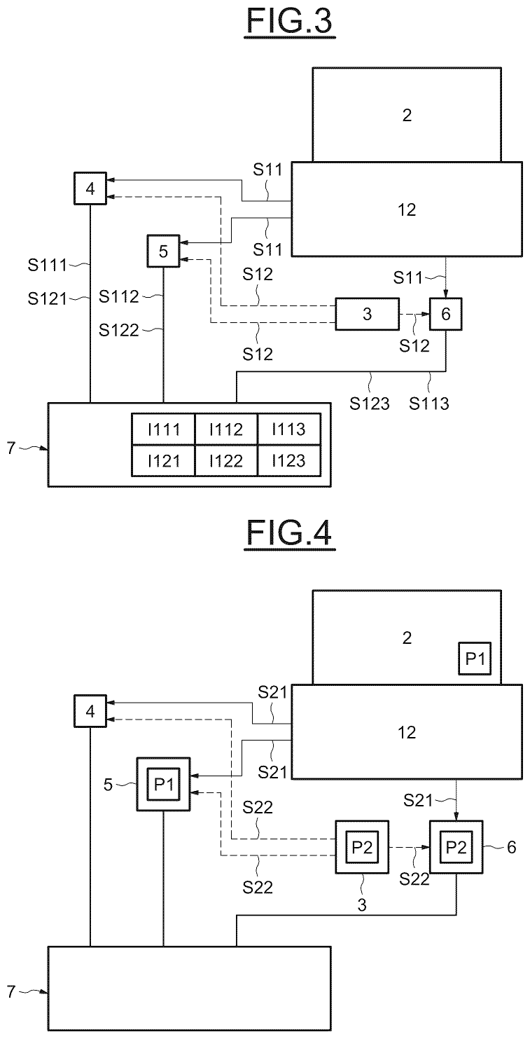

During a step 22, each gateway 4, 5, 6 receives each first signal S11, S12 (FIG. 3).

A first gateway 4 delivers to the network supervisor 7 a first signal S111 representative of the received first signal S11 emitted by the first sensor 2 and a second signal S121 representative of the received first signal S12 emitted by the second sensor 3.

A second gateway 5 delivers to the network supervisor 7 a first signal S112 representative of the received first signal S11 emitted by the first sensor 2 and a second signal S122 representative of the received first signal S12 emitted by the second sensor 3.

The third gateway 6 delivers to the network supervisor 7 a first signal S113 representative of the received first signal S11 emitted by the first sensor 2 and a second signal S123 representative of the received first signal S12 emitted by the second sensor 3.

The determining means 13 of the network supervisor 7 determine for each gateway 4, 5, 6 a signal reception quality score I111, I112, I113, I121, I122, I123 of each first signal S11, S12 to quantify the quality of the reception of the first signal by the said gateway.

The signal reception quality score I111, I112, I113, I121, I122, I123 may be a signal-to-noise ratio SNR, a received signal strength indication level RSSI or a link metric criteria based on the number of packet send/received.

The signal reception quality score I111, I112, I113 of the first signal S11 received by the gateways 4, 5, 6 is determined by the determining means 13 from the first signal S111, S112, S113 representative of the received first signal S11 emitted by the first sensor 2.

The signal reception quality score I121, I122, I123 of the second signal S12 received by the gateways 4, 5, 6 is determined by the determining means 13 from the first signal S121, S122, S123 representative of the received second signal S12 emitted by the second sensor 3.

During a step 23 (FIG. 2), the choosing means 14 of the network supervisor 7 compare the signal reception quality score I111, I112, I113 of the first signal S11 received by the gateways 4, 5, 6 and choose a first selected gateway of the gateways 4, 5, 6, the first selected gateway being associated with the highest signal reception quality score of the signal reception quality scores I111, I112, I113.

The choosing means 14 further compare the signal reception quality score I121, I122, I133 of the second signal S12 received by the gateways 4, 5, 6 and choose a second selected gateway of the gateways 4, 5, 6, the second selected gateway being associated with the highest signal reception quality score of the signal reception quality scores I121, I122, I123.

It is assumed that the choosing means 14 choose the signal reception quality score I112, the first selected gateway being the second gateway 5, and the signal reception quality score I123, the second selected gateway being the third gateway 6.

The processing unit 16 sends to the second gateway 5 connection information so that only the second gateway 5 processes signals emitted by the first sensor 2.

The processing unit 16 further sends to the third gateway 6 connection information so that only the third gateway 6 processes signals emitted by the second sensor 3.

The second gateway 5 is associated with the first sensor 2, and the third gateway 6 is associated with the second sensor 3 so that only the second gateway 5 processes signals emitted by the first sensor 2 and only the third gateway 6 processes signals emitted by the second sensor 3.

During a step 24, after a first predetermined duration has elapsed, the control means 9 of each sensor 2, 3 start the said sensor 2, 3 so that each sensor 2, 3 switches in the active mode.

The first predetermined duration is chosen so that the choosing means 14 of the network supervisor 7 has chosen the second gateway 5 and the third gateway 6 when the said duration has elapsed.

The first predetermined first duration starts from the emission of the first signal S11, S12.

The predetermined first duration may be determined from tests.

The emitting means 8 of each sensor 2, 3 emit a second signal S21, S22 (FIG. 4).

Each second signal S21, S22 comprises a connectable frame.

The second signal S21 comprising a first connectable frame is emitted by the emitting means 8 of the first sensor 2, received by the gateways 4, 5, 6.

As the second gateway 5 is associated with the first sensor 2, the second gateway 5 processes the second signal S21 comprising the first connectable frame to establish a communication between the first sensor 2 and the second gateway 5.

As the first and third gateways 4, 6 don't have received connection information from the processing unit 16 during step 23 to establish a connection with the first sensor 2, the first and third gateways 4, 6 don't process the first connectable frame.

The second signal S22 comprising a second connectable frame is emitted by the emitting means of the second sensor 3 and received by the gateways 4, 5, 6.

As the third gateway 6 is associated with the second sensor 3, the third gateway 6 processes the second signal S22 comprising the second connectable frame to establish a communication between the second sensor 3 and the third gateway 6.

As the first and second gateways 4, 5 don't have received connection information from the processing unit 16 during step 23 to establish a connection with the second sensor 3, the first and second gateways 4, 5 don't process the second connectable frame.

During a step 25 (FIG. 2), the measuring means 10 of each sensor 2, 3 measures for example a temperature.

The emitting means 8 of the first sensor 2 emit a third signal S31 comprising data extracted from the measurements delivered by the measuring means 10.

The second gateway 5 processes the third signal S31 and delivered to the network supervisor 7 a signal S311 representative of the data of the third signal S31.

The emitting means of the second sensor 3 emit a third signal S32 comprising data extracted from the measurements delivered by the measuring means of the second sensor 3.

The third gateway 6 processes the third signal S32 emitted by the second sensor 3 and delivered to the network supervisor 7 a signal S321 representative of the data of the third signal S32 emitted by the second sensor 3.

The extraction means 15 of the network supervisor 7 reconstitute the measurements from the third signal S31, S32 emitted by the sensors 2, 3 for further processing.

In variant, the sensors 2, 3 are not send in the sleep mode and stay in the active mode, the method going from step 23 to step 25.

During a step 26 (FIG. 2), after emission of the third signals S31, S32, the control means 9 of each sensor 2, 3 switch the said sensor 2, 3 in the sleep mode.

Steps 20 to 26 are repeated after a predetermined second duration has elapsed since the switch of the sensor in a sleep mode after emitting the third signal.

The second duration is for example equal to 8 hours.

Although each sensor 2, 3 is associated with a different gateway 5, 6, according to the configuration of the sensors relative to the gateways, the two sensors 2, 3 may be paired with the same gateway.

Further, when the steps 20 to 26 are repeated, the two sensors 2, 3 may be paired with at least another gateway.

The association of each sensor with the gateway having a highest signal reception quality score permits to optimize the quality of the transmission of measurements to avoid that the sensor has to emit at least two times same measurements to reduce the power consumption of the sensor.

As the sensor may comprise a battery, the duration of the battery is extended.

As the pairing of each sensor with a gateway is repeated before the emission of the third signal comprising data extracted from the measurements, the method takes into account in real time the modification of environment of the sensor and the gateways.

For example, if a vehicle is parked between the first sensor 2 and the second gateway 5 generating interferences which deteriorate the quality of the signal transmission, for next measurements, when steps 20 to 26 are repeated, another gateway may be chosen to enhance the quality of the signal transmission.

Further, the sensor is switched in the sleep mode when it does not emit a signal or taken measurements reducing even more the power consumption of the sensor.

What is claimed is:

1. A method for connecting at least one wireless sensor to a first gateway of a plurality of gateways, the method comprising:
a) an emission of a first signal comprising a non-connectable frame by the sensor,
b) for each gateway, a determination of a signal reception quality score of the first signal to quantify the quality of the reception of the first signal by the said gateway,
c) a choice of a selected gateway from the plurality of gateways, the selected gateway having the highest signal reception quality score.

2. The method according to claim 1, wherein the sensor is in a sleep mode, the method comprises:
d) a first start of the sensor before emitting the first signal,
e) a first switch of the sensor in the sleep mode after sending the first signal,
f) a second start of the sensor when a first predetermined duration has elapsed, the selected gateway being chosen during the first predetermined duration,
g) an emission of a second signal by the sensor, the second signal comprising a connectable frame, the second signal being processed by the selected gateway to establish a communication between the sensor and the selected gateway,
h) an emission of a third signal by the sensor, the third signal comprising data extracted from measurements taken by the said sensor, the third signal being processed by the selected gateway, and
i) a second switch of the sensor is the sleep mode after sending the third signal.

3. The method according to claim 2, wherein steps a) to i) are repeated after a predetermined duration.

4. A network comprising:
at least one wireless sensor comprising emitting means configured to emit a first signal comprising a non-connectable frame,
a plurality of gateways, and
a network supervisor,
the network supervisor comprising:
determining means configured to determine for each gateway a signal reception quality score of the first signal to quantify the quality of the reception of the first signal by the said gateway, and
choosing means configured to choose a selected gateway from the plurality of gateways, the selected gateway having the highest signal reception quality score.

5. The network according to claim 4, wherein the wireless sensor comprises a battery.

6. The network according to claim 4, wherein the wireless sensor further comprises control means configured to:
start the sensor before emitting the first signal and after a first predetermined duration has elapsed, the first predetermined duration being chosen so that the network supervisor has chosen the selected gateway during the said duration, and
switch the sensor in a sleep mode after sending the first signal and after sending a third signal, the emitting means being further configured to:
emit a second signal comprising a connectable frame to establish a communication between the sensor and the selected gateway, and
emit the third signal comprising data extracted from measurements taken by the said sensor.

7. The network according to claim 6, wherein the network supervisor comprises extraction means configured to reconstitute the measurements from the third signal.

8. The network according to claim 6, wherein the control means are further configured to start the sensor before emitting the first signal each time a predetermined duration has elapsed since the switch of the sensor in a sleep mode after emitting the third signal.

9. The network according to claim 4, wherein the wireless sensor comprises measuring means configured to measure a temperature and/or an acceleration.

10. The network according to claim 5, wherein the wireless sensor further comprises control means configured to:
start the sensor before emitting the first signal and after a first predetermined duration has elapsed, the first predetermined duration being chosen so that the network supervisor has chosen the selected gateway during the said duration, and
switch the sensor in a sleep mode after sending the first signal and after sending a third signal, the emitting means being further configured to:
emit a second signal comprising a connectable frame to establish a communication between the sensor and the selected gateway, and
emit the third signal comprising data extracted from measurements taken by the said sensor.

11. The network according to claim 10, wherein the network supervisor comprises extraction means configured to reconstitute the measurements from the third signal.

12. The network according to claim 11, wherein the control means are further configured to start the sensor before emitting the first signal each time a predetermined duration has elapsed since the switch of the sensor in a sleep mode after emitting the third signal.

13. The network according to claim 12, wherein the wireless sensor comprises measuring means configured to measure a temperature and/or an acceleration.
